(19) United States
(12) Patent Application Publication
(10) Pub. No.: US 2017/0366256 A1
(43) Pub. Date: Dec. 21, 2017

(54) OPTICAL COMPONENT

(71) Applicant: FUJITSU LIMITED, Kawasaki-shi (JP)

(72) Inventor: Atsushi Miki, Kawasaki (JP)

(73) Assignee: FUJITSU LIMITED, Kawasaki-shi (JP)

(21) Appl. No.: 15/603,797

(22) Filed: May 24, 2017

(30) Foreign Application Priority Data
Jun. 20, 2016 (JP) 2016-121367

(51) Int. Cl. H04B 10/035; H04B 10/40; H04Q 11/00

(52) U.S. Cl. CPC H04B 10/035; H04Q 11/0005; H04B 10/40; H04Q 2011/0043

(57) ABSTRACT

An optical component includes a light emitter; an optical receiver; first and second electro-optical crystal layers configured to intersect with each other; and a control line configured to supply a signal for changing refractive indexes of the first and second electro-optical crystal layers, wherein the first and second electro-optical crystal layers are switched according to the signal between a first state where light from the light emitter is transmitted through the first electro-optical crystal layer and a second state where the light is reflected by the first and second electro-optical crystal layers and the reflected light is incident on the optical receiver.

### CROSS-REFERENCE TO RELATED APPLICATION

This application is based upon and claims the benefit of priority of the prior Japanese Patent Application No. 2016-121367, filed on Jun. 20, 2016, the entire contents of which are incorporated herein by reference.

### FIELD

The embodiments discussed herein are related to an optical component.

### BACKGROUND

In the related art, in a supercomputer or the like, a technique for performing optical communication using an optical module is known. In addition, in a case where an abnormality is detected in the optical communication by the optical module, a technique for specifying a failure occurrence place which causes the abnormality is known (for example, refer to Japanese Laid-open Patent Publication No. 2011-211565 and Japanese Laid-open Patent Publication No. 5-199192). In such a technique, for example, an optical loopback in which a transmitted signal is returned in an optical processing section is used.

However, in the techniques in the related art, there is a problem that it is difficult to reduce the size of an optical component in which an optical loopback can be realized. For example, when an optical path switch including a movable portion is used to realize an optical loopback, the size of an optical component is increased due to the optical path switch.

### SUMMARY

According to an aspect of the embodiments, an apparatus includes includes a light emitter; an optical receiver; first and second electro-optical crystal layers configured to intersect with each other; and a lead wire configured to supply a signal for changing refractive indexes of the first and second electro-optical crystal layers, wherein the first and second electro-optical crystal layers are switched according to the signal between a first state where light from the light emitter is transmitted through the first electro-optical crystal layer and a second state where the light is reflected by the first and second electro-optical crystal layers and the reflected light is incident on the optical receiver.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of an optical path during communication in an optical component according to a first embodiment;

FIG. 2 is a diagram illustrating an example of an optical path during optical loopback in the optical component according to the first embodiment;

FIG. 3 is a diagram illustrating an example of an optical transmission system to which the optical component according to the first embodiment is applied;

FIG. 4 is a diagram illustrating an example of an optical path during signal transmission in the optical transmission system according to the first embodiment;

FIG. 5 is a diagram illustrating an example of an optical path in a first state of the electrical loopback in the optical transmission system according to the first embodiment;

FIG. 6 is a diagram illustrating an example of an optical path in a second state of the electrical loopback in the optical transmission system according to the first embodiment;

FIG. 7 is a diagram illustrating an example of an optical path in a first state of the optical loopback in the optical transmission system according to the first embodiment;

FIG. 8 is a diagram illustrating an example of an optical path in a second state of the optical loopback in the optical transmission system according to the first embodiment;

FIG. 9 is a flowchart illustrating an example of processing by the central controller of the optical transmission system according to the first embodiment;

FIG. 10 is a diagram illustrating an example of an optical path during communication in an optical component according to a second embodiment;

FIG. 11 is a diagram illustrating an example of an optical path during optical loopback in the optical component according to the second embodiment;

FIG. 12 is a diagram illustrating an example of an optical transmission system to which the optical component according to the second embodiment is applied;

FIG. 13 is a diagram illustrating an example of an optical path during communication in an optical component according to a third embodiment; and

FIG. 14 is a diagram illustrating an example of an optical path during optical loopback in the optical component according to the third embodiment.

### DESCRIPTION OF EMBODIMENTS

Hereinafter, embodiments of an optical component according to the present disclosure will be described in detail with reference to the drawings.

Optical Path during communication in Optical Component according to First Embodiment

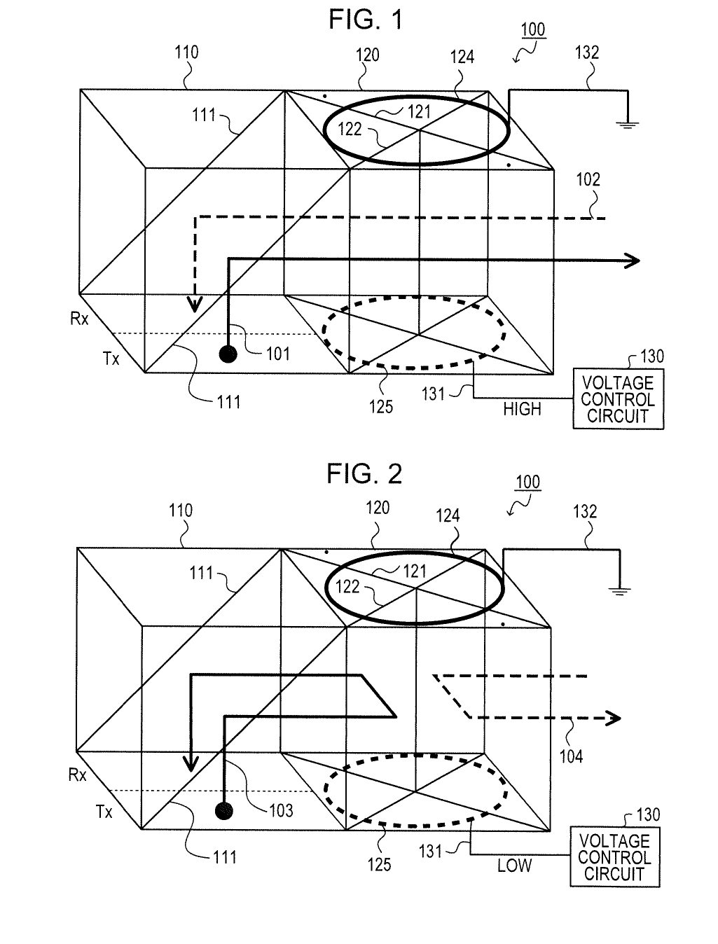

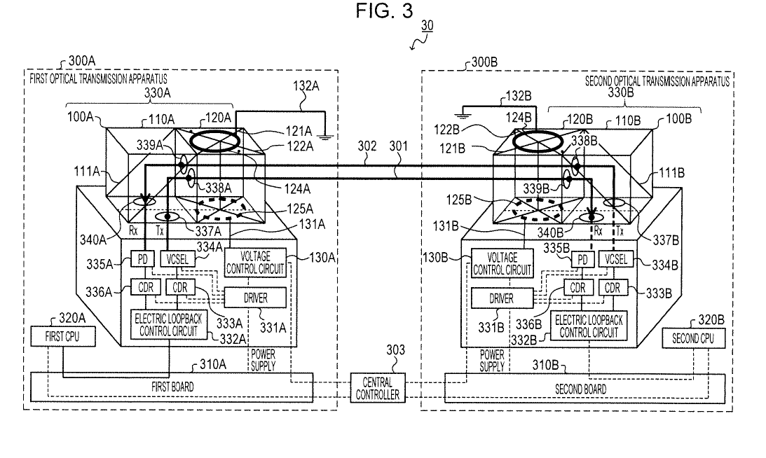

FIG. 1 is a diagram illustrating an example of an optical path during communication in an optical component according to a first embodiment. As illustrated in FIG. 1, an optical component 100 according to the first embodiment is, for example, an optical component with a built-in loop-back function that includes a block 110, a block 120, a voltage control circuit 130, and a control line 131. The optical component 100 is provided in an optical module (for example, refer to FIG. 3) including a light emitter (Tx: transmitter) and an optical receiver (Rx).

A transmission path 101 is a path through which light incident from the light emitter (Tx) of the optical module provided with the optical component 100 is emitted to an optical transmission line. A reception path 102 is a path through which light incident from an optical module opposite to the optical module provided with the optical component 100 via the optical transmission line is emitted to the optical receiver (Rx: receiver) of the optical module provided with the optical component 100.

The block 110 is a block that is formed by providing a reflection layer 111, for example, in a cubic block through which light is transmitted. The reflection layer 111 is provided at an angle of 45 degrees with respect to one set of adjacent surfaces (the bottom surface and the right surface in FIG. 1) in the cubic block. The reflection layer 111 reflects light emitted from the light emitter (Tx) of the optical module provided with the optical component 100 at an incident angle of 45 degrees (changes the angle of the light by 90 degrees) to emit the light to the block 120. In addition, the reflection layer 111 reflects light which is incident from the optical transmission line and is emitted from the block 120 at an incident angle of 45 degrees to emit the light to the optical receiver (Rx) of the optical module provided with the optical component 100.

For example, in a case where a VCSEL (Vertical Cavity Surface Emitting LASER) is used for the light emitter (Tx) of the optical module, light is emitted from the VCSEL provided on the base in a direction perpendicular to the base. The VCSEL is a semiconductor laser. On the other hand, the optical transmission line such as an optical fiber is provided in a direction parallel to the base. The traveling direction of the light is changed by the reflection layer 111 using the block 110, and thus the light emitted from the VCSEL can be incident on the optical fiber.

The block 120 is formed, for example, by providing electro-optical crystal layers 121 and 122 in a cubic block through which light is transmitted. The electro-optical crystal layers 121 and 122 are formed to be intersected with each other on diagonal lines of the cubic block. For example, the electro-optical crystal layer 121 is provided at an angle of 45 degrees with respect to one set of adjacent surfaces (the left surface and the rear surface in FIG. 1) in the cubic block. The electro-optical crystal layer 122 is provided at an angle of 45 degrees with respect to one set of adjacent surfaces (the left surface and the front surface in FIG. 1) in the cubic block. The electro-optical crystal layers 121 and 122 are perpendicularly intersected with each other.

The electro-optical crystal layers 121 and 122 are transmission plates or mirrors. Each of the electro-optical crystal layers 121 and 122 is switched according to the voltage of the control signal applied from the voltage control circuit 130 via the control line 131. For example, the refractive indexes of the electro-optical crystal layers 121 and 122 are switched according to the voltage applied from the voltage control circuit 130. Therefore, the refractive indexes are switched, and thus switching is achieved between a state where the incident light is totally reflected and a state where the incident light is transmitted.

As an example, the electro-optical crystal layers 121 and 122 can be realized by using a thin film which is made of kalium tantalum-niobate (KTN) crystals having a large change in the refractive index with respect to the applied voltage due to a large electro-optical coefficient (for example, an electro-optical coefficient of 600 pm/V or more). Here, the electro-optical crystal layers 121 and 122 can be made by various electro-optical crystals each of which the transmittance changes according to the applied voltage. For example, the electro-optical crystal layers 121 and 122 be made by using lithium niobate.

The following embodiments use that the electro-optical crystal layers 121 and 122 are made from KTN.

The reflection layer 111 in the block 110 and the electro-optical crystal layers 121 and 122 in the block 120 can be formed, for example, by a TSSG method, a LPE method, or the like. The TSSG is an abbreviation for top seeded solution growth. The LPE is an abbreviation for liquid phase epitaxy. Here, the method for forming the reflection layer 111 and the electro-optical crystal layers 121 and 122 is not limited thereto, and various forming methods can be used.

In a case where the optical module provided with the optical component 100 performs optical communication with the opposing optical module via the optical component 100, as illustrated in FIG. 1, the voltage applied between a first conductor 125 connected to the voltage control circuit 130 via a control line 131 and a second conductor 124 connected to a ground through a line 132. The applied voltage to the electro-optical crystal layers (use of KTN) 121 and 122 is controlled to be HIGH (for example, a voltage larger than 0 V). Each of the first conductor 125 and the second conductor 124 may be formed with a circle line or a conductor plate or the like. In this case, the electro-optical crystal layers 121 and 122 have a relatively low first refractive index, and are in a state where the incident light is transmitted.

The applied voltage is larger than 0 V, the electro-optical crystal layers 121 and 122 of the block 120 transmit the light on the transmission path 101 that is emitted from the block 110 to emit the light to the optical transmission line. Accordingly, the light transmitted from the optical module provided with the optical component 100 is transmitted to the opposing optical module. The electro-optical crystal layers 121 and 122 of the block 120 transmit the light incident from the optical transmission line to emit the light to the block 110. Accordingly, the light transmitted from the opposing optical module is received by the optical module provided with the optical component 100.

Optical Path during Optical Loopback in Optical Component according to First Embodiment

FIG. 2 is a diagram illustrating an example of an optical path during optical loopback in the optical component according to the first embodiment. In FIG. 2, components similar to those illustrated in FIG. 1 are denoted by the same reference numerals, and description thereof is omitted. In a case where the optical loopback is formed by using the optical component 100, for example, as illustrated in FIG. 2, the voltage applied from the voltage control circuit 130 to the electro-optical crystal layers 121 and 122 between the first conductor 125 and the second conductor 124. The first conductor 125 is controlled to be LOW (for example, 0 V). The first conductor 125 is connected to voltage control circuit 130 through the line 131 and the second conductor 124 is connected to the ground through the line 132.

In this case, the electro-optical crystal layers 121 and 122 have a second refractive index higher than the first refractive index, and are in a state where the incident light is totally reflected. In other words, the electro-optical crystal layers 121 and 122 return the light on the transmission path 103 that is emitted from the block 110 by respectively reflecting the light at an incident angle of 45 degrees to emit the light to the optical receiver (Rx) of the optical module provided with the optical component 100. Accordingly, the light transmitted from the optical module provided with the optical component 100 is returned to the optical module provided with the optical component 100.

In addition, the electro-optical crystal layers 121 and 122 return the light which is incident from the optical transmission line by respectively reflecting the light at an incident angle of 45 degrees to emit the light to the optical transmission line. Accordingly, the light transmitted from the optical module opposite to the optical module provided with the optical component 100 is returned to the optical module opposite to the optical module provided with the optical component 100.

The return path 103 is a path through which the light incident from the light emitter (Tx) of the optical module provided with the optical component 100 is returned by the electro-optical crystal layers 121 and 122 and is emitted to the optical receiver (Rx) of the optical module provided with the optical component 100. The return path 104 is a path through which the light incident from the optical transmission line is returned by the electro-optical crystal layers 121 and 122 and is emitted to the optical transmission line.

As illustrated in FIGS. 1 and 2, according to the optical component 100, the optical communication path (refer to FIG. 1) and the optical loopback path can be switched by controlling the voltage applied to the electro-optical crystal layers 121 and 122 via the first conductor 125 and the second conductor 124. Further, the optical component 100 can switch the optical path by controlling the voltage applied to the electro-optical crystal layers 121 and 122, and thus a small-sized optical component can be adopted, compared to a configuration in which the optical loopback is implemented, for example, by using an optical path switch including a movable portion.

Optical Transmission System to which Optical Component according to First Embodiment is applied

FIG. 3 is a diagram illustrating an example of an optical transmission system to which the optical component according to the first embodiment is applied. The optical transmission system 30 illustrated in FIG. 3 includes a first optical transmission apparatus 300A, a second optical transmission apparatus 300B, optical transmission lines 301 and 302, and a central controller 303.

The first optical transmission apparatus 300A and the second optical transmission apparatus 300B are opposite to each other and perform optical communication with each other via the optical transmission lines 301 and 302. The optical transmission line 301 is an optical transmission line such as an optical fiber that transmits an optical signal from the first optical transmission apparatus 300A to the second optical transmission apparatus 300B. The optical transmission line 302 is an optical transmission line such as an optical fiber that transmits an optical signal from the second optical transmission apparatus 300B to the first optical transmission apparatus 300A.

The central controller 303 is a control circuit that controls the first optical transmission apparatus 300A and the second optical transmission apparatus 300B. The control by the central controller 303 includes specifying a failure occurrence place in a case where an abnormality is detected in the link between the first optical transmission apparatus 300A and the second optical transmission apparatus 300B.

For example, as illustrated in FIG. 3, the central controller 303 is provided at the outside of the first optical transmission apparatus 300A and the second optical transmission apparatus 300B, and is a device that can communicate with the first optical transmission apparatus 300A and the second optical transmission apparatus 300B. In this case, various types of communication such as electrical communication, optical communication, or wireless communication can be used for the communication between the first optical transmission apparatus 300A and the second optical transmission apparatus 300B and the central controller 303. Here, the central controller 303 may be a controller provided in any one of the first optical transmission apparatus 300A and the second optical transmission apparatus 300B.

The first optical transmission apparatus 300A includes a first board 310A, a first CPU 320A, and a first optical module 330A. The CPU is an abbreviation for central processing unit. The first board 310A is a base of the first optical transmission apparatus 300A. The first CPU 320A and the first optical module 330A are connected to the first board 310A. The first board 310A supplies power to the first optical module 330A. Further, the first board 310A can communicate with the central controller 303.

The first CPU 320A controls the optical communication by the first optical module 330A. For example, the first CPU 320A outputs a signal to be transmitted by using the optical signal, to the first optical module 330A. Further, the first CPU 320A acquires a signal that is obtained by converting an optical signal received by the first optical module 330A into an electrical signal.

The first CPU 320A controls switching between enabling and disabling of the electrical loopback in the electrical loopback control circuit 332A via the first board 310A. Further, the first CPU 320A transmits the detection result of the link abnormality in the optical communication by the first optical module 330A, or the detection result of the signal in the electrical loopback and the optical loopback to be described later, to the central controller 303 via the first board 310A.

The first optical module 330A is an optical module that performs optical communication with the second optical transmission apparatus 300B under the control of the first CPU 320A. The first optical module 330A includes a first optical component 100A, a driver 331A, an electrical loopback control circuit 332A, a CDR 333A, a VCSEL 334A, a PD 335A, a CDR 336A, and a voltage control circuit 130A. The CDR is an abbreviation for clock data recovery. The PD is an abbreviation for photo detector.

The driver 331A supplies a drive voltage based on the power supplied from the first board 310A, to the CDR 333A, the VCSEL 334A, the PD 335A, the CDR 336A, and the voltage control circuit 130A.

The electrical loopback control circuit 332A can switch enabling and disabling of the electrical loopback in own circuit under the control of the first CPU 320A. For example, in a case where the electrical loopback in the electrical loopback control circuit 332A is disabled, the electrical loopback control circuit 332A outputs the signal that is output from the first CPU 320A to the CDR 336A as it is. In a case where the electrical loopback in the electrical loopback control circuit 332A is disabled, the electrical loopback control circuit 332A outputs the signal that is output from the CDR 336A to the first CPU 320A as it is.

Further, in a case where the electrical loopback in the electrical loopback control circuit 332A is enabled, the electrical loopback control circuit 332A returns the signal that is output from the first CPU 320A to own circuit, and outputs the returned signal to the first CPU 320A. In a case where the electrical loopback in the electrical loopback control circuit 332A is enabled, the electrical loopback control circuit 332A returns the signal that is output from the CDR 336A to own circuit, and outputs the returned signal to the CDR 333A.

The CDR 333A performs clock data recovery processing at the transmission side for the signal that is output from the electrical loopback control circuit 332A, and outputs the signal that is subjected to the clock data recovery processing to the VCSEL 334A. The clock data recovery processing includes, for example, processing of extracting a clock from an input signal and shaping the signal. The VCSEL 334A is a light emitter that converts a signal output from the CDR 333A into an optical signal and emits the converted optical signal to the first optical component 100A.

The first optical component 100A has a configuration corresponding to the optical component 100 illustrated in FIG. 1. The reference numerals that are obtained by adding A to the end of the reference numerals of the components of the optical component 100 are given to the components of the first optical component 100A. Further, lenses 337A, 338A, 339A, and 340A are provided in the first optical component 100A.

The lens 337A is provided on the surface of the block 110A on the VCSEL 334A side (the bottom surface in FIG. 3), collimates light emitted from the VCSEL 334A, and emits the light to the reflection layer 111A. The lens 338A is provided on the surface of the block 110A on the block 120A side (the right surface in FIG. 3), condenses light that is emitted from the lens 337A and reflected by the reflection layer 111A, and emits the light to the block 120A.

The lens 339A is provided on the surface of the block 110A on the block 120A side (the right surface in FIG. 3), collimates light that is emitted from the block 120A, and emits the light to the reflection layer 111A. The lens 340A is provided on the surface of the block 110A on the PD 335A side (the bottom surface in FIG. 3), condenses light that is emitted from the lens 339A and reflected by the reflection layer 111A, and emits the light to the PD 335A.

The PD 335A is an optical receiver that converts light emitted from the first optical component 100A into an electrical signal and outputs the converted electrical signal to the CDR 336A. The CDR 336A performs clock data recovery processing at the receiving side for the signal that is output from the PD 335A, and outputs the signal that is subjected to the clock data recovery processing to the electrical loopback control circuit 332A.

The voltage control circuit 130A has a configuration corresponding to the voltage control circuit 130 illustrated in FIG. 1. The voltage control circuit 130A applies a voltage to the electro-optical crystal layers 121A and 122A between the first conductor 125A and the second conductor 124B. The first conductor 125A is provided from the drive voltage supplied from the driver 331A. The first conductor 125A is connected to voltage control circuit 130A through the line 131A and the second conductor 124A is connected to the ground through the line 132A. Further, the voltage control circuit 130A switches the voltage applied to the electro-optical crystal layers 121A and 122A via the control line 131A under the control of the central controller 303 via the first board 310A. Here, the voltage control circuit 130A may control the voltage under the control of the central controller 303 via the first board 310A and the first CPU 320A.

In a case where the voltage that is applied to the electro-optical crystal layers 121A and 122A by the voltage control circuit 130A is HIGH, as illustrated in FIG. 3, the light emitted from the VCSEL 334A is transmitted to the second optical transmission apparatus 300B via the optical transmission line 301. Further, the light transmitted from the second optical transmission apparatus 300B via the optical transmission line 302 is incident on the PD 335A.

In a case where the voltage that is applied to the electro-optical crystal layers 121A and 122A by the voltage control circuit 130A is LOW, the light emitted from the VCSEL 334A is returned by the block 120A and is incident on the PD 335A. Further, the light transmitted from the second optical transmission apparatus 300B via the optical transmission line 302 is returned by the block 120A, and is transmitted to the second optical transmission apparatus 300B via the optical transmission line 301.

The configuration of the second optical transmission apparatus 300B is the same as that of the first optical transmission apparatus 300A. The reference numerals that are obtained by replacing A in the end of the reference numerals of the components of the first optical transmission apparatus 300A with B are given to the components of the second optical transmission apparatus 300B.

In a case where the voltage that is applied to the electro-optical crystal layers 121B and 122B between the first conductor 125B and the second conductor 124B. the drive voltage to the first conductor 125B is provided by the voltage control circuit 130B of the second optical transmission apparatus 300B is HIGH, as illustrated in FIG. 3, the light emitted from the VCSEL 334B is transmitted to the first optical transmission apparatus 300A via the optical transmission line 302. The first conductor 125B is connected to voltage control circuit 130B through the control line 131B and the second conductor 124B is connected to the ground through the line 132. Further, the light transmitted from the first optical transmission apparatus 300A via the optical transmission line 301 is incident on the PD 335B.

In a case where the voltage that is applied to first conductor 125B and the electro-optical crystal layers 121B and 122B via the first and second conductors 125B and 124B by the voltage control circuit 130B is LOW, the light emitted from the VCSEL 334B is returned by the block 120B and is incident on the PD 335B. Further, the light transmitted from the first optical transmission apparatus 300A via the optical transmission line 301 is returned by the block 120B, and is transmitted to the first optical transmission apparatus 300A via the optical transmission line 302.

Optical Path During Signal Transmission in Optical Transmission System According to First Embodiment

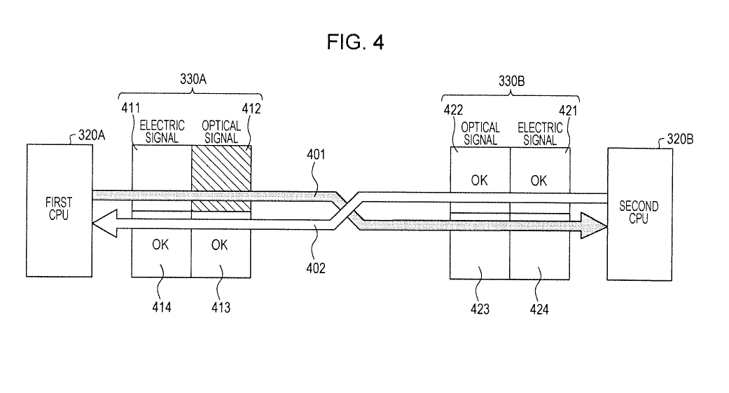

FIG. 4 is a diagram illustrating an example of an optical path during signal transmission in the optical transmission system according to the first embodiment. In FIG. 4, components similar to those illustrated in FIG. 3 are denoted by the same reference numerals, and description thereof is omitted.

As illustrated in FIG. 4, the first optical module 330A can be divided into an electrical transmission section 411, an optical transmission section 412, an optical reception section 413, and an electrical reception section 414. The electrical transmission section 411 includes, for example, the electrical loopback control circuit 332A and the CDR 333A illustrated in FIG. 3. The optical transmission section 412 includes, for example, the VCSEL 334A and the first optical component 100A illustrated in FIG. 3. The optical reception section 413 includes, for example, the first optical component 100A and the PD 335A illustrated in FIG. 3. The electrical reception section 414 includes, for example, the CDR 336A and the electrical loopback control circuit 332A illustrated in FIG. 3.

Similarly, the second optical module 330B illustrated in FIG. 3 can be divided into an electrical transmission section 421, an optical transmission section 422, an optical reception section 423, and an electrical reception section 424. The electrical transmission section 421 includes, for example, the electrical loopback control circuit 332B and the CDR 333B illustrated in FIG. 3. The optical transmission section 422 includes, for example, the VCSEL 334B and the second optical component 100B illustrated in FIG. 3. The optical reception section 423 includes, for example, the second optical component 100B and the PD 335B illustrated in FIG. 3. The electrical reception section 424 includes, for example, the CDR 336B and the electrical loopback control circuit 332B illustrated in FIG. 3.

In a case where the link abnormality is detected, the central controller 303 specifies a failure occurrence place among the electrical transmission sections 411 and 421, the optical transmission sections 412 and 422, the optical reception sections 413 and 423, the electrical reception sections 414 and 424, and the optical transmission lines 301 and 302 (refer to FIG. 3).

The path 401 is a path of the signal that is output from the first CPU 320A to the first optical module 330A. The path 402 is a path of the signal that is output from the second CPU 320B to the second optical module 330B. In a case where actual data transmission is performed between the first optical transmission apparatus 300A and the second optical transmission apparatus 300B, the paths 401 and 402 are as illustrated in FIG. 4.

The path 401 illustrated in FIG. 4 includes the first CPU 320A, the electrical transmission section 411, the optical transmission section 412, the optical reception section 423, the electrical reception section 424, and the second CPU 320B. The path 402 illustrated in FIG. 4 includes the second CPU 320B, the electrical transmission section 421, the optical transmission section 422, the optical reception section 413, the electrical reception section 414, and the first CPU 320A.

As an example, it is assumed that a failure such as a fault occurs in the optical transmission section 412 (shaded area). In this case, since a failure does not occur in the path 402, the first CPU 320A can normally receive the signal from the second CPU 320B. Accordingly, it can be determined that the electrical transmission section 421, the optical transmission section 422, the optical transmission line 302, the optical reception section 413, and the electrical reception section 414 in the path 402 are “OK” (no failure).

On the other hand, due to the failure of the optical transmission section 412 in the path 401, the second CPU 320B is unable to normally receive the signal from the first CPU 320A. Accordingly, it can be determined that a failure occurs in any one of the electrical transmission section 411, the optical transmission section 412, the optical transmission line 301, the optical reception section 423, and the electrical reception section 424 in the path 401.

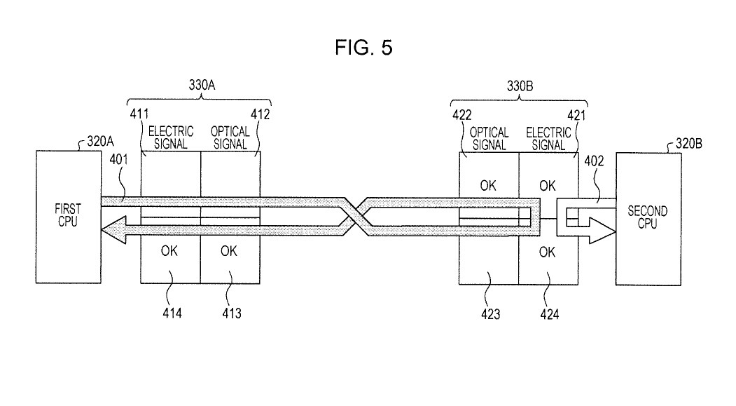

The second CPU 320B notifies the central controller 303 of the fact that the signal from the first board 310A is not normally received, by using the control signal. In response to the notification, the central controller 303 starts to specify a failure occurrence place by using the electrical loopback and the optical loopback (for example, refer to FIGS. 5 to 8).

Optical Path in First State of Electrical Loopback in Optical Transmission System According to First Embodiment

FIG. 5 is a diagram illustrating an example of an optical path in a first state of the electrical loopback in the optical transmission system according to the first embodiment. In FIG. 5, components similar to those illustrated in FIG. 4 are denoted by the same reference numerals, and description thereof is omitted. As illustrated in FIG. 4, in a case where the second CPU 320B is unable to normally receive the signal from the first CPU 320A, the central controller 303 first enables the electrical loopback of the second optical transmission apparatus 300B, for example. Accordingly, the paths 401 and 402 are as illustrated in FIG. 5.

The path 401 illustrated in FIG. 5 includes the first CPU 320A, the electrical transmission section 411, the optical transmission section 412, the optical transmission line 301, the optical reception section 423, the electrical reception section 424, the electrical transmission section 421, the optical transmission section 422, the optical transmission line 302, the optical reception section 413, the electrical reception section 414, and the first CPU 320A. The path 402 illustrated in FIG. 5 includes the second CPU 320B, the electrical transmission section 421, the electrical reception section 424, and the second CPU 320B.

In this case, since a failure does not occur in the path 402, the second CPU 320B can normally receive the signal from the second CPU 320B. Accordingly, in the path 402, it can be newly determined that the electrical reception section 424 is “OK”, excluding the components determined as “OK”. On the other hand, due to the failure of the optical transmission section 412 in the path 401, the first CPU 320A is unable to normally receive the signal from the first CPU 320A. Accordingly, in the path 401, it can be determined that a failure occurs in any one of the electrical transmission section 411, the optical transmission section 412, the optical transmission line 301, and the optical reception section 423 excluding the components determined as “OK”.

Optical Path in Second State of Electrical Loopback in Optical Transmission System according to First Embodiment

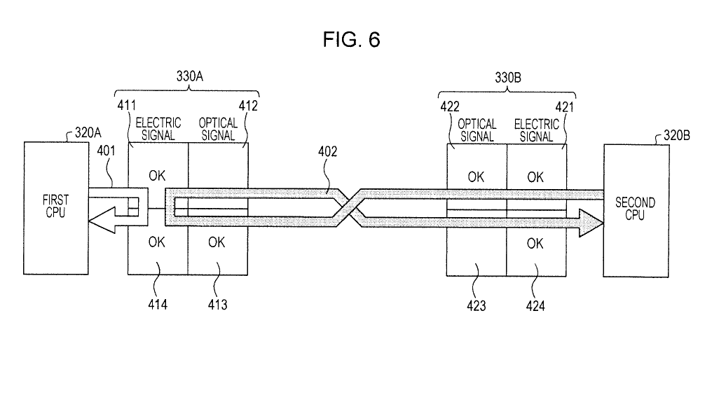

FIG. 6 is a diagram illustrating an example of an optical path in a second state of the electrical loopback in the optical transmission system according to the first embodiment. In FIG. 6, components similar to those illustrated in FIG. 5 are denoted by the same reference numerals, and description thereof is omitted. After enabling the electrical loopback of the second optical transmission apparatus 300B as illustrated in FIG. 5, the central controller 303 disables the electrical loopback of the second optical transmission apparatus 300B, and enables the electrical loopback of the first optical transmission apparatus 300A. Accordingly, the paths 401 and 402 are as illustrated in FIG. 6.

The path 401 illustrated in FIG. 6 includes the first CPU 320A, the electrical transmission section 411, the electrical reception section 414, and the first CPU 320A. The path 402 illustrated in FIG. 6 includes the second CPU 320B, the electrical transmission section 421, the optical transmission section 422, the optical transmission line 302, the optical reception section 413, the electrical reception section 414, the electrical transmission section 411, the optical transmission section 412, the optical transmission line 301, the optical reception section 423, the electrical reception section 424, and the second CPU 320B.

In this case, since a failure does not occur in the path 401, the first CPU 320A can normally receive the signal from the first CPU 320A. Accordingly, in the path 401, it can be newly determined that the electrical transmission section 411 is “OK”, excluding the components determined as “OK”.

On the other hand, due to the failure of the optical transmission section 412 in the path 402, the second CPU 320B is unable to normally receive the signal from the second CPU 320B. Accordingly, in the path 402, it can be determined that a failure occurs in any one of the optical transmission section 412, the optical transmission line 301, and the optical reception section 423 excluding the components determined as “OK”.

As illustrated in FIGS. 5 and 6, in the electrical loopback, the signal output from each CPU is returned in the electrical module (electrical loopback control circuits 332A and 332B). Accordingly, it can be determined that a failure does not occur in the electrical path portion (the electrical transmission section 411 or the electrical reception section 414) of the first optical module 330A, or in the electrical path portion (the electrical transmission section 421 or the electrical reception section 424) of the second optical module 330B.

Although a case where a failure occurs in the optical transmission section 412 is described, in contrast, in a case where a failure occurs in the electrical path portion of the first optical module 330A or the electrical path portion of the second optical module 330B, it is possible to determine the failure occurrence place at this point.

Optical Path in First State of Optical Loopback in Optical Transmission System according to First Embodiment

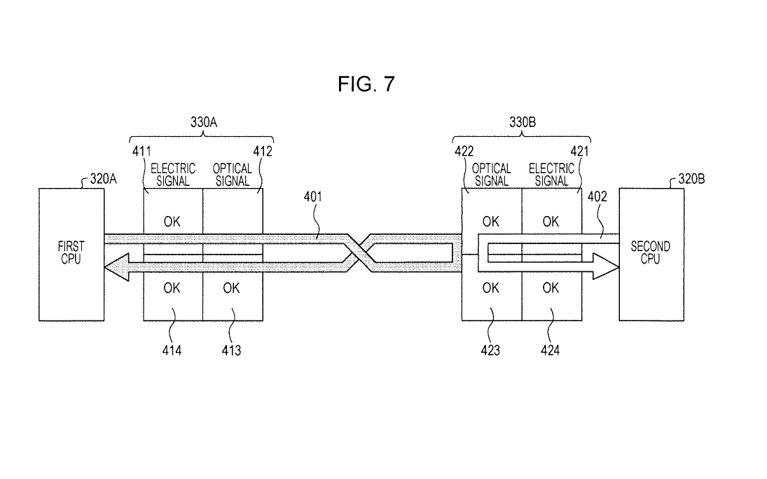

FIG. 7 is a diagram illustrating an example of an optical path in a first state of the optical loopback in the optical transmission system according to the first embodiment. In FIG. 7, components similar to those illustrated in FIG. 6 are denoted by the same reference numerals, and description thereof is omitted. After enabling the electrical loopback of the first optical transmission apparatus 300A as illustrated in FIG. 6, the central controller 303 disables the electrical loopback of the first optical transmission apparatus 300A, and enables the optical loopback of the second optical transmission apparatus 300B. Accordingly, the paths 401 and 402 are as illustrated in FIG. 7.

The path 401 illustrated in FIG. 7 includes the first CPU 320A, the electrical transmission section 411, the optical transmission section 412, the optical transmission lines 301 and 302, the optical reception section 413, the electrical reception section 414, and the first CPU 320A. The path 401 is returned by the block 120B included in the optical transmission section 422 and the optical reception section 423. Here, it is assumed that a failure does not occur in the return portion of the block 120B and the optical transmission section 422 and the optical reception section 423 are excluded from the path 401. The path 402 illustrated in FIG. 7 includes the second CPU 320B, the electrical transmission section 421, the optical transmission section 422, the optical reception section 423, the electrical reception section 424, and the second CPU 320B.

In this case, since a failure does not occur in the path 402, the second CPU 320B can normally receive the signal from the second CPU 320B. Accordingly, in the path 402, it can be newly determined that the optical reception section 423 is “OK”, excluding the components determined as “OK”.

On the other hand, due to the failure of the optical transmission section 412 in the path 401, the first CPU 320A is unable to normally receive the signal from the first CPU 320A. Accordingly, in the path 401, it can be determined that a failure occurs in any one of the optical transmission section 412 and the optical transmission line 301 excluding the components determined as “OK”.

Optical Path in Second State of Optical Loopback in Optical Transmission System according to First Embodiment

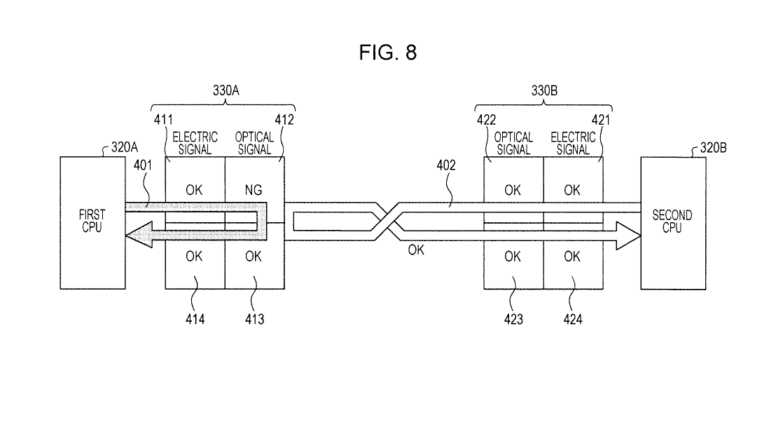

FIG. 8 is a diagram illustrating an example of an optical path in a second state of the optical loopback in the optical transmission system according to the first embodiment. In FIG. 8, components similar to those illustrated in FIG. 7 are denoted by the same reference numerals, and description thereof is omitted. After enabling the optical loopback of the second optical transmission apparatus 300B as illustrated in FIG. 7, the central controller 303 disables the optical loopback of the second optical transmission apparatus 300B, and enables the optical loopback of the first optical transmission apparatus 300A. Accordingly, the paths 401 and 402 are as illustrated in FIG. 8.

The path 401 illustrated in FIG. 8 includes the first CPU 320A, the electrical transmission section 411, the optical transmission section 412, the optical reception section 413, the electrical reception section 414, and the first CPU 320A. The path 402 illustrated in FIG. 8 includes the second CPU 320B, the electrical transmission section 421, the optical transmission section 422, the optical transmission line 302, the optical transmission line 301, the optical reception section 423, the electrical reception section 424, and the second CPU 320B. The path 402 is returned by the block 120A included in the optical reception section 413 and the optical transmission section 412. Here, it is assumed that a failure does not occur in the return portion of the block 120A and the optical transmission section 412 and the optical reception section 413 are excluded from the path 402.

In this case, since a failure does not occur in the path 402, the second CPU 320B can normally receive the signal from the second CPU 320B. Accordingly, in the path 402, it can be newly determined that the optical transmission line 301 is “OK”, excluding the components determined as “OK”.

On the other hand, due to the failure of the optical transmission section 412 in the path 401, the first CPU 320A is unable to normally receive the signal from the first CPU 320A. Accordingly, in the path 401, it can be determined that a failure occurs in the optical transmission section 412 excluding the components determined as “OK”. In this way, it can be determined that a failure occurs in the optical transmission section 412 (the optical transmission section 412 is “NG”).

As illustrated in FIGS. 7 and 8, in the optical loopback, the signal output from each CPU is returned in the optical module (the first optical component 100A and the second optical component 100B). Accordingly, it can be determined that the optical transmission section 412 among the optical transmission section 412, the optical reception section 413, and the optical transmission line 301 is a failure occurrence place.

Processing by Central Controller of Optical Transmission System according to First Embodiment

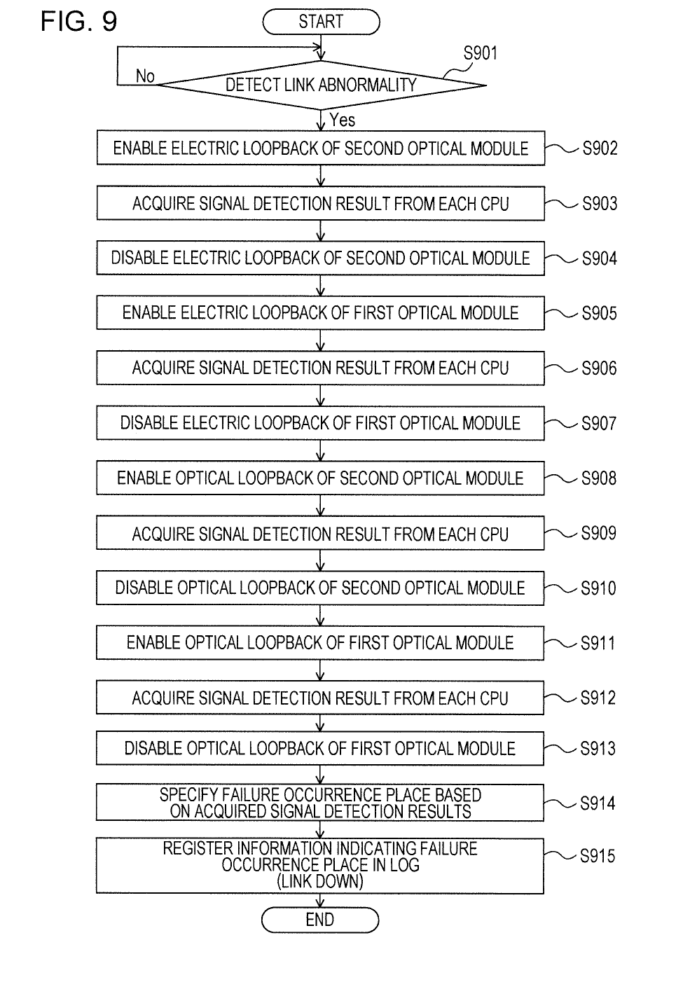

FIG. 9 is a flowchart illustrating an example of processing by the central controller of the optical transmission system according to the first embodiment. The central controller 303 executes the steps illustrated in FIG. 9, for example. First, the central controller 303 determines whether or not an abnormality in the link between the first optical component 100A and the second optical component 100B is detected (step S901), and waits until the link abnormality is detected (No loop in S901).

In step S901, for example, the central controller 303 waits until a signal indicating a link abnormality between the first optical component 100A and the second optical component 100B is received from the first CPU 320A, or the second CPU 320B, or any combination thereof. The link abnormality includes, for example, an abnormality that occurs at the time of link up when the first optical component 100A and the second optical component 100B are activated, and an abnormality that occurs during signal transmission after link up between the first optical component 100A and the second optical component 100B.

In step S901, when the link abnormality is detected (Yes in step S901), the central controller 303 enables the electrical loopback of the second optical module 330B (step S902). For example, the central controller 303 enables the electrical loopback of the second optical module 330B by transmitting a signal for instructing the second CPU 320B to enable the electrical loopback of the electrical loopback control circuit 332B to the second CPU 320B. Accordingly, the signals output from the first CPU 320A and the second CPU 320B are respectively returned (for example, refer to FIG. 5) in the electrical module of the second optical module 330B.

Next, the central controller 303 acquires the signal detection result from the first CPU 320A and the second CPU 320B (each CPU) (step S903). The signal detection result acquired from the first CPU 320A by the central controller 303 is information indicating whether or not the first CPU 320A can normally receive the signal which is output from the first CPU 320A and returned. The signal detection result acquired from the second CPU 320B by the central controller 303 is information indicating whether or not the second CPU 320B can normally receive the signal which is output from the second CPU 320B and returned.

Next, the central controller 303 disables the electrical loopback of the second optical module 330B (step S904). For example, the central controller 303 disables the electrical loopback of the second optical module 330B by transmitting a signal for instructing the second CPU 320B to disable the electrical loopback of the electrical loopback control circuit 332B to the second CPU 320B.

Next, the central controller 303 enables the electrical loopback of the first optical module 330A (step S905). For example, the central controller 303 enables the electrical loopback of the first optical module 330A by transmitting a signal for instructing the first CPU 320A to enable the electrical loopback of the electrical loopback control circuit 332A to the first CPU 320A. Accordingly, the signals output from the first CPU 320A and the second CPU 320B are respectively returned (for example, refer to FIG. 6) in the electrical module of the first optical module 330A.

Next, the central controller 303 acquires the signal detection result from the first CPU 320A and the second CPU 320B (each CPU) (step S906). Next, the central controller 303 disables the electrical loopback of the first optical module 330A (step S907). For example, the central controller 303 disables the electrical loopback of the first optical module 330A by transmitting a signal for instructing the first CPU 320A to disable the electrical loopback of the electrical loopback control circuit 332A to the first CPU 320A.

Next, the central controller 303 enables the optical loopback of the second optical module 330B (step S908). For example, the central controller 303 enables the optical loopback of the second optical module 330B by transmitting a signal for instructing the voltage control circuit 130B to switch the voltage applied to the electro-optical crystal layers 121B and 1226 from HIGH to LOW to the voltage control circuit 130B. Accordingly, the signals output from the first CPU 320A and the second CPU 320B are respectively returned (for example, refer to FIG. 7) in the optical module of the second optical module 330B.

Next, the central controller 303 acquires the signal detection result from the first CPU 320A and the second CPU 320B (each CPU) (step S909). Next, the central controller 303 disables the optical loopback of the second optical module 330B (step S910). For example, the central controller 303 disables the optical loopback of the second optical module 330B by transmitting a signal for instructing the voltage control circuit 1306 to switch the voltage applied to the electro-optical crystal layers 121B and 122B from LOW to HIGH to the voltage control circuit 130B.

Next, the central controller 303 enables the optical loopback of the first optical module 330A (step S911). For example, the central controller 303 enables the optical loopback of the first optical module 330A by transmitting a signal for instructing the voltage control circuit 130A to switch the voltage applied to the electro-optical crystal layers 121A and 122A from HIGH to LOW to the voltage control circuit 130A. Accordingly, the signals output from the first CPU 320A and the second CPU 3206 are respectively returned (for example, refer to FIG. 8) in the optical module of the first optical module 330A.

Next, the central controller 303 acquires the signal detection result from the first CPU 320A and the second CPU 3206 (each CPU) (step S912). Next, the central controller 303 disables the optical loopback of the first optical module 330A (step S913). For example, the central controller 303 disables the optical loopback of the second optical module 3306 by transmitting a signal for instructing the voltage control circuit 130A to switch the voltage applied to the electro-optical crystal layers 121A and 122A from LOW to HIGH to the voltage control circuit 130A.

Next, the central controller 303 specifies a failure occurrence place based on the signal detection results acquired in steps S903, S906, S909, and S912 (step S914). Next, the central controller 303 registers information indicating the failure occurrence place specified in step S914 in a predetermined log (step S915), and ends a series of processing. The predetermined log is, for example, a log stored in a memory of the central controller 303. Further, in step S915, the central controller 303 may control link down between the first optical component 100A and the second optical component 100B.

As described above, the optical component 100 according to the first embodiment includes the electro-optical crystal layers 121 and 122 on the transmission path and the reception path. The electro-optical crystal layers 121 and 122 can be switched between a first state where the light on the transmission path and the light on the reception path are respectively transmitted, and a second state where the light from the light emitter is reflected and is incident on the optical receiver and the light from the second optical transmission line is reflected and emitted to the first optical transmission line.

Further, switching between the first state and the second state in the electro-optical crystal layers 121 and 122 is performed according to the control signal applied via the control line 131. Accordingly, the optical loopback can be implemented without using, for example, an optical path switch including a movable portion, and thus it is possible to reduce the size of the optical component in which the optical loopback can be implemented.

A second embodiment will be described focusing on the differences from the first embodiment. In the first embodiment, the configuration in which the reflection layer 111 and the electro-optical crystal layers 121 and 122 are respectively provided in the blocks 110 and 120 is described. In contrast, in the second embodiment, a configuration in which the reflection layer and the electro-optical crystal layers are provided in one block will be described.

Optical Path during communication in Optical Component according to Second Embodiment

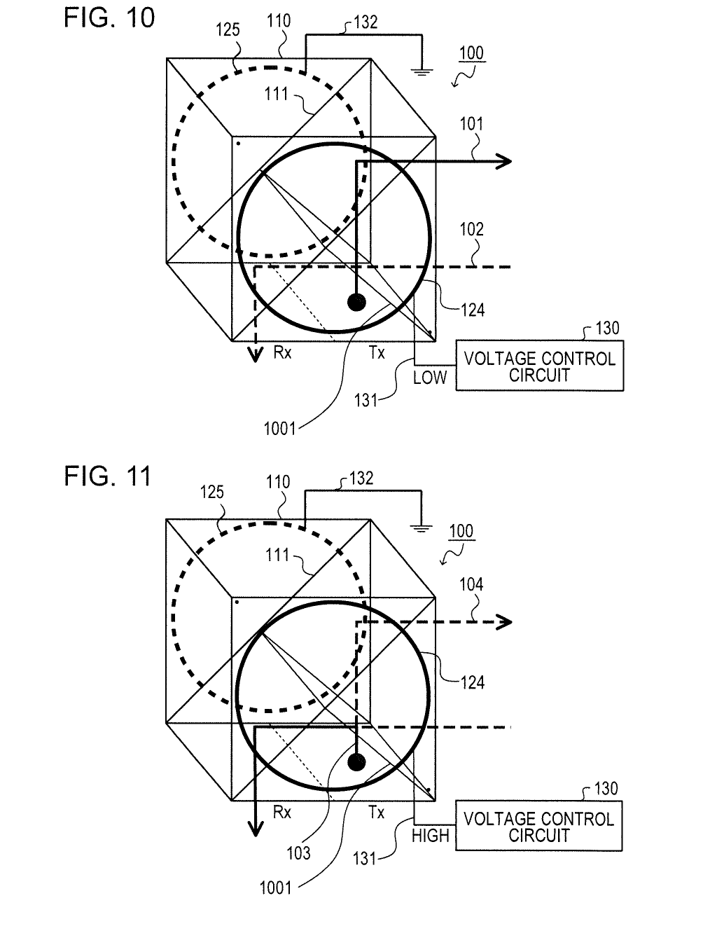

FIG. 10 is a diagram illustrating an example of an optical path during communication in an optical component according to the second embodiment. In FIG. 10, components similar to those illustrated in FIG. 1 are denoted by the same reference numerals, and description thereof is omitted. As illustrated in FIG. 10, an optical component 100 according to the second embodiment includes, for example, a block 110, a voltage control circuit 130, and a control line 131.

In the optical component 100 according to the second embodiment, the electro-optical crystal layer 1001 is further provided in the block 110 in which the reflection layer 111 is provided. The electro-optical crystal layer 1001 is provided at an angle of 45 degrees with respect to one set of adjacent surfaces (the bottom surface and the right surface in FIG. 10) in the cubic block and in a direction perpendicular to the reflection layer 111.

The electro-optical crystal layer 1001 is a half mirror of which the transmittance is switched according to the voltage applied from the voltage control circuit 130 via the control line 131, similar to the electro-optical crystal layers 121 and 122 via the first and second conductors 125 and 124 illustrated in FIG. 1. In addition, similar to the electro-optical crystal layers 121 and 122 illustrated in FIG. 1, the electro-optical crystal layer 1001 can be made by using an electro-optical crystal layer such as KTN or lithium niobate. Further, the electro-optical crystal layer 1001 can be formed, for example, by a TSSG method, a LPE method, or the like.

The following embodiments use that the electro-optical crystal layers 121 and 122 are made from KTN.

In a case where the optical module provided with the optical component 100 performs optical communication with the opposing optical module via the optical component 100, as illustrated in FIG. 1, the voltage applied from the voltage control circuit 130 to the electro-optical crystal layer 1001 is controlled to be HIGH (for example, a voltage larger than 0 V). In this case, the electro-optical crystal layer 1001 has a low refractive index, and is in a state where the incident light is transmitted.

In this case, the electro-optical crystal layer 1001 transmits the light on the transmission path 101 that is emitted from the light emitter (Tx) of the optical module provided with the optical component 100 to emit the light to the reflection layer 111. The reflection layer 111 reflects the light emitted from the electro-optical crystal layer 1001 to emit the light to the optical transmission line. Accordingly, the light transmitted from the optical module provided with the optical component 100 is transmitted to the opposing optical module.

Further, the electro-optical crystal layer 1001 transmits the light which is incident from the optical transmission line to emit the light to the reflection layer 111. The reflection layer 111 reflects the light emitted from the electro-optical crystal layer 1001 to emit the light to the optical receiver (Rx) of the optical module provided with the optical component 100. Accordingly, the light transmitted from the opposing optical module is received by the optical module provided with the optical component 100.

Optical Path During Optical Loopback in Optical Component According to Second Embodiment

FIG. 11 is a diagram illustrating an example of an optical path during optical loopback in the optical component according to the second embodiment. In FIG. 11, components similar to those illustrated in FIG. 10 are denoted by the same reference numerals, and description thereof is omitted.

In a case where the optical loopback is formed by using the optical component 100, for example, as illustrated in FIG. 11, the voltage applied from the voltage control circuit 130 to the electro-optical crystal layer 1001 via the first conductor 125 and the second conductor 124 is controlled to be LOW (for example, 0 V). In this case, the electro-optical crystal layer 1001 has a higher refractive index than a lower refractive index. The lower refractive index that is the voltage applied to electro-optical crystal layer 1001 via the first and second conductor 125 and 124 is HIGH and the higher refractive index (LOW) is in a state where the incident light is totally reflected.

In other words, the electro-optical crystal layer 1001 reflects the light on the transmission path 101 that is emitted from the light emitter (Tx) of the optical module provided with the optical component 100 at an incident angle of 45 degrees to emit the light to the reflection layer 111. The light that is emitted from the light emitter (Tx) and is emitted from the electro-optical crystal layer 1001 to the reflection layer 111 is reflected by the reflection layer 111 at an incident angle of 45 degrees, and is emitted to the optical receiver (Rx) of the optical module provided with the optical component 100. Accordingly, the light transmitted from the optical module provided with the optical component 100 is returned to the optical module provided with the optical component 100.

Further, the electro-optical crystal layer 1001 reflects the light which is incident from the optical transmission line at an incident angle of 45 degrees to emit the light to the reflection layer 111. The light which is incident from the optical transmission line and is emitted from the electro-optical crystal layer 1001 to the reflection layer 111 is reflected by the reflection layer 111 at an incident angle of 45 degrees, and is emitted to the optical transmission line. Accordingly, the light transmitted from the optical module opposite to the optical module provided with the optical component 100 is returned to the optical module opposite to the optical module provided with the optical component 100.

As illustrated in FIGS. 10 and 11, in the optical component 100 according to the second embodiment, the electro-optical crystal layer 1001 that switches the optical path according to the voltage applied from the voltage control circuit 130 is provided in the block 110 including the reflection layer 111. Accordingly, as the optical component 100, an optical component smaller than, for example, the optical component 100 illustrated in FIGS. 1 and 2 can be adopted.

For example, in the optical module using the VCSEL as described above, the block 110 that includes the reflection layer 111 for changing the traveling direction of the light is used. In contrast, in the second embodiment, the electro-optical crystal layer 1001 can be provided in the block 110. Accordingly, even without increasing the size of the optical component 100, the optical loopback for switching the optical path according to the voltage applied from the voltage control circuit 130 can be implemented.

Optical Transmission System to which Optical Component According to Second Embodiment is Applied

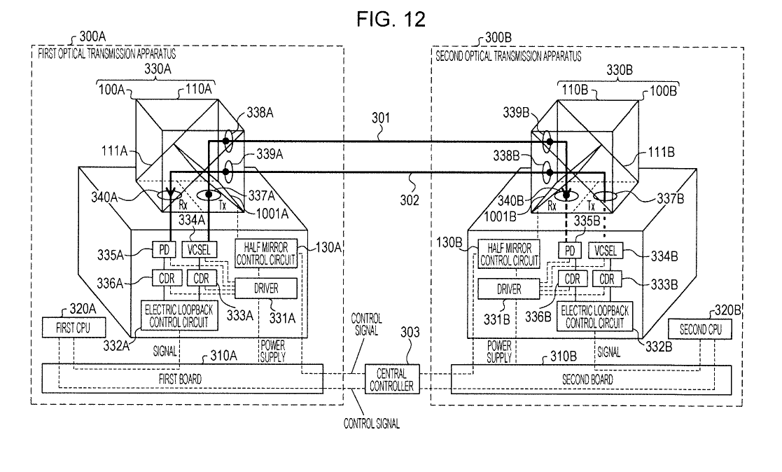

FIG. 12 is a diagram illustrating an example of an optical transmission system to which the optical component according to the second embodiment is applied. In FIG. 12, components similar to those illustrated in FIG. 3 are denoted by the same reference numerals, and description thereof is omitted. However, to avoid the complicated Figure, the first conductor 125 and the second conductor 124 are omitted from FIG. 12. When the optical component 100 illustrated in FIGS. 10 and 11 is applied to the first optical component 100A and the second optical component 100B illustrated in FIG. 3, the optical transmission system is configured as illustrated in FIG. 12.

For example, the first optical component 100A includes a block 110A including a reflection layer 111A and an electro-optical crystal layer 1001A, instead of the block 110 and the block 120 illustrated in FIG. 1. The lens 338A condenses light that is emitted from the lens 337A and reflected by the reflection layer 111A, and emits the light to the optical transmission line 301. The lens 339A collimates light emitted from the optical transmission line 302, and emits the light to the reflection layer 111A. The voltage control circuit 130A controls the voltage applied to the electro-optical crystal layer 1001A via the first conductor 125 and second conductor 124.

As described above, the optical component 100 according to the second embodiment includes the electro-optical crystal layer 1001 on the transmission path and the reception path. The electro-optical crystal layer 1001 can be switched between a first state where the light on the transmission path and the light on the reception path are respectively transmitted, and a second state where the light from the light emitter is reflected and is incident on the optical receiver and where the light from the second optical transmission line is reflected and emitted to the first optical transmission line.

In addition, switching between the first state and the second state in the electro-optical crystal layer 1001 is performed according to the control signal applied via the control line 131. Accordingly, the optical loopback can be implemented without using, for example, an optical path switch including a movable portion, and thus it is possible to reduce the size of the optical component in which the optical loopback can be implemented.

The electro-optical crystal layer 1001 is provided in combination with the reflection layer 111 that changes the direction of the light which is perpendicularly emitted from the VCSEL to the direction of the optical transmission line. That is, in the first state, the electro-optical crystal layer 1001 transmits the light from the VCSEL to emit the light to the reflection layer 111. Also, in the first state, the electro-optical crystal layer 1001 transmits the light which is incident from the second optical transmission line to emit the light to the reflection layer 111.

In addition, in the second state, the electro-optical crystal layer 1001 reflects the light which is incident from the VCSEL to emit the light to the reflection layer 111 before the light reaches the reflection layer 111, and the light is emitted to the optical receiver. Further, in the second state, the electro-optical crystal layer 1001 reflects the light which is incident from the second optical transmission line to emit the light to the reflection layer 111 before the light reaches the reflection layer 111, and the light is emitted to the first optical transmission line.

Accordingly, it is possible to dispose the reflection layer 111 that changes the direction of the light which is perpendicularly emitted from the VCSEL to the direction of the optical transmission line, and the electro-optical crystal layer 1001 that forms the return path for the optical loopback, in a space-saving manner. Therefore, it is possible to reduce the size of the optical component that is provided on the base using the VCSEL and in which the optical loopback can be implemented.

### Third Embodiment

A third embodiment will be described focusing on the differences from the first and second embodiments. In the first and second embodiments, the configuration in which the VCSEL is used for the optical transmission section is described. In contrast, in the third embodiment, a configuration in which a laser diode (LD) is used instead of the VCSEL for the optical transmission section will be described.

Optical Path During Communication in Optical Component According to Third Embodiment

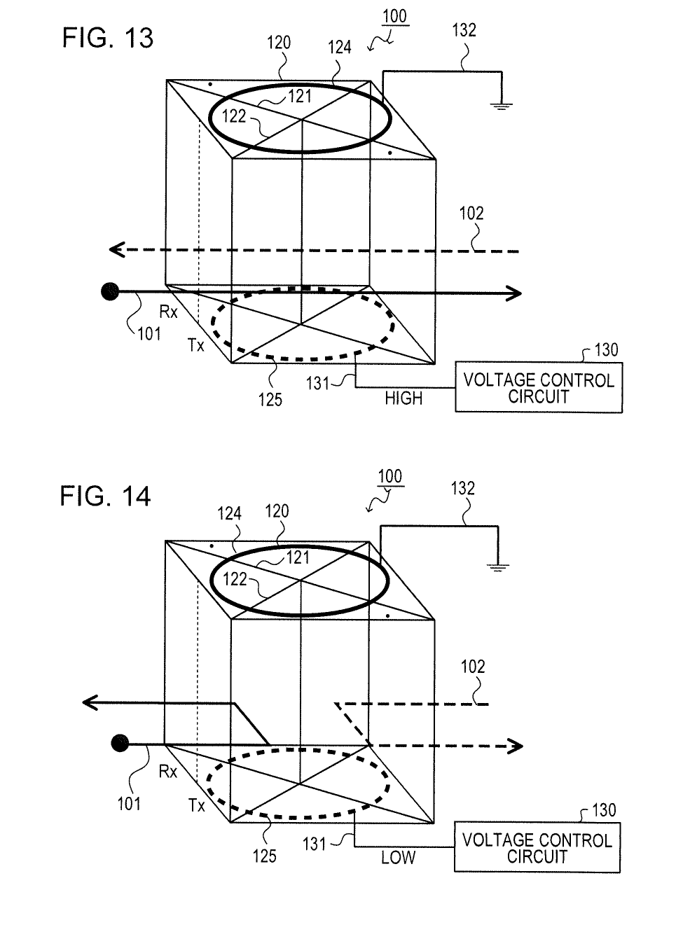

FIG. 13 is a diagram illustrating an example of an optical path during communication in an optical component according to the third embodiment. In FIG. 13, components similar to those illustrated in FIG. 1 are denoted by the same reference numerals, and description thereof is omitted. For example, in a case where an LD that emits light parallel to the base is used instead of the VCSEL for the optical transmission section of the optical module provided with the optical component 100, the reflection layer 111 that changes the direction of the light from the optical transmission section may not be provided. Therefore, as illustrated in FIG. 13, for example, the optical component 100 may have a configuration in which the block 110 illustrated in FIG. 1 is omitted. In a case where the voltage applied to the electro-optical crystal layers 121 and 122 via the first conductor 125 and the second conductor 124 by the voltage control circuit 130 is HIGH, paths of light are as illustrated in FIG. 13.

That is, the electro-optical crystal layers 121 and 122 transmits the light on the transmission path 101 that is emitted from the light emitter (Tx) of the optical module provided with the optical component 100 to emit the light to the optical transmission line. Accordingly, the light transmitted from the optical module provided with the optical component 100 is transmitted to the opposing optical module.

In addition, the electro-optical crystal layers 121 and 122 transmit the light which is incident from the optical transmission line to emit the light to the optical receiver (Rx) of the optical module provided with the optical component 100. Accordingly, the light transmitted from the opposing optical module is received by the optical module provided with the optical component 100.

Optical Path During Optical Loopback in Optical Component According to Third Embodiment

FIG. 14 is a diagram illustrating an example of an optical path during optical loopback in the optical component according to the third embodiment. In FIG. 14, components similar to those illustrated in FIG. 13 are denoted by the same reference numerals, and description thereof is omitted. In a case where the optical loopback is formed by using the optical component 100, for example, as illustrated in FIG. 14, the voltage applied from the voltage control circuit 130 to the electro-optical crystal layers 121 and 122 via the first conductor 125 and the second conductor 124 is controlled to be LOW (for example, 0 V). In this case, the electro-optical crystal layers 121 and 122 have a high refractive index, and are in a state where the incident light is totally reflected.

That is, the electro-optical crystal layers 121 and 122 return the light on the transmission path 101 that is emitted from the light emitter (Tx) of the optical module provided with the optical component 100 by respectively reflecting the light at an incident angle of 45 degrees to emit the light to the optical receiver (Rx) of the optical module. Accordingly, the light transmitted from the optical module provided with the optical component 100 is returned to the optical module provided with the optical component 100.

In addition, the electro-optical crystal layers 121 and 122 return the light which is incident from the optical transmission line by respectively reflecting the light at an incident angle of 45 degrees to emit the light to the optical transmission line. Accordingly, the light transmitted from the optical module opposite to the optical module provided with the optical component 100 is returned to the optical module opposite to the optical module provided with the optical component 100.

As described above, according to the optical component 100 of the third embodiment, for example, in a configuration in which an LD that emits light parallel to the base is used, similarly to the first embodiment, it is possible to reduce the size of the optical component in which the optical loopback can be implemented.

As described above, according to the optical component, it is possible to reduce the size of the optical component in which the optical loopback can be implemented.

For example, in the case of connecting CPUs in a supercomputer or the like by an optical communication path, two opposing optical modules are used. In a case where a transmission abnormality occurs in the optical communication by the two optical modules, from the view point of the maintenance, it is preferable to specify a failure occurrence place among the two optical modules and the optical transmission line.

In this regard, for example, a method of specifying a failure occurrence place by using an electrical loopback and an optical loopback is considered. However, when an optical path switch including a movable portion is used to make the optical loopback, the size of the optical component is increased due to the optical path switch.

Also, a method of specifying a failure occurrence place by reconnecting each optical module and each optical cable and changing the combination of the optical modules is considered. However, in a supercomputer, for example, there is a case where one optical cable is shared by a plurality of optical modules via a fiber box, or there is a case where the optical path other than the maintenance object is also influenced by reconnecting the cables.

In contrast, according to each of the embodiments described above, the electro-optical crystal layer (half mirror) such as KIN is used, and thus the optical path can be changed by the control signal applied to the electro-optical crystal layer. Therefore, it is possible to make the optical loopback without increasing the size of the optical component. Further, it is possible to specify a failure occurrence place without reconnecting the cables.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An optical component comprising:
a light emitter;
an optical receiver;
first and second electro-optical crystal layers configured to intersect with each other; and
a control line configured to supply a signal for changing refractive indexes of the first and second electro-optical crystal layers,
wherein the first and second electro-optical crystal layers are switched according to the signal between a first state where light from the light emitter is transmitted through the first electro-optical crystal layer and a second state where the light is reflected by the first and second electro-optical crystal layers and the reflected light is incident on the optical receiver.

2. An optical component comprising:
a light emitter;
an optical receiver;
a transmission path through which first light from the light emitter is incident and the first light is emitted to a first optical transmission line;
a reception path through which second light from a second optical transmission line is incident and the second light is emitted to the optical receiver;
electro-optical crystal layers configured to be switched according to an input signal between a first state where the first light on the transmission path and the second light on the reception path are respectively transmitted, and a second state where the first light which is incident from the light emitter is reflected and emitted to the optical receiver and where the second light which is incident from the second optical transmission line is reflected and emitted to the first optical transmission line; and
a control line configured to input the input signal to the electro-optical crystal layers.

3. The optical component according to claim 2,
wherein a refractive index of each of the electro-optical crystal layers is changed according to a voltage of the signal,
wherein, in the first state, each of the electro-optical crystal layers has a first refractive index to transmit the first light on the transmission path and the second light on the reception path, and
wherein, in the second state, each of the electro-optical crystal layers has a second refractive index higher than the first refractive index to totally reflect the first light which is incident from the light emitter and the second light which is incident from the second optical transmission line.

4. The optical component according to claim 2,
wherein the electro-optical crystal layers are made by using a kalium tantalum-niobate crystal.

5. The optical component according to claim 2,
wherein the light emitter is a vertical cavity surface emitting laser,
wherein a reflection layer is included in the transmission path and the reception path in a case where each of the electro-optical crystal layers is in the first state, the reflection layer being configured to reflect the light which is incident from the vertical cavity surface emitting laser to emit the light to the first optical transmission line, and being configured to reflect the light which is incident from the second optical transmission line to emit the light to the optical receiver,
wherein, in the first state, each of the electro-optical crystal layers transmits the light which is incident from the vertical cavity surface emitting laser and reflected by the reflection layer to emit the light to the first optical transmission line, and transmits the light which is incident from the second optical transmission line to emit the light to the reflection layer, and
wherein, in the second state, each of the electro-optical crystal layers reflects the light which is incident from the vertical cavity surface emitting laser and reflected by the reflection layer toward the reflection layer to emit the light to the optical receiver, and reflects the light which is incident from the second optical transmission line before the light reaches the reflection layer to emit the light to the first optical transmission line.

6. The optical component according to claim 2,
wherein the light emitter is a vertical cavity surface emitting laser,
wherein a reflection layer is included in the transmission path and the reception path in a case where each of the electro-optical crystal layers is in the first state, the reflection layer being configured to reflect the light which is incident from the vertical cavity surface emitting laser to emit the light to the first optical transmission line, and being configured to reflect the light which is incident from the second optical transmission line to emit the light to the optical receiver,
wherein, in the first state, each of the electro-optical crystal layers transmits the light which is incident from the vertical cavity surface emitting laser to emit the light to the reflection layer, and transmits the light which is incident from the second optical transmission line to emit the light to the reflection layer, and
wherein, in the second state, each of the electro-optical crystal layers reflects the light which is incident from the vertical cavity surface emitting laser toward the reflection layer before the light reaches the reflection layer to emit the light to the optical receiver, and reflects the light which is incident from the second optical transmission line toward the reflection layer before the light reaches the reflection layer to emit the light to the first optical transmission line.

7. The optical component according to claim 6,
wherein the reflection layer reflects the light which is incident from the vertical cavity surface emitting laser at an incident angle of 45 degrees to emit the light to the first optical transmission line, and reflects the light which is incident from the second optical transmission line at an incident angle of 45 degrees to emit the light to the optical receiver, and
wherein, each of the electro-optical crystal layers is provided in a direction perpendicular to the reflection layer, and in the second state, each of the electro-optical crystal layers reflects the light which is incident from the vertical cavity surface emitting laser at an incident angle of 45 degrees toward the reflection layer before the light reaches the reflection layer to emit the light to the optical receiver, and reflects the light which is incident from the second optical transmission line at an incident angle of 45 degrees toward the reflection layer before the light reaches the reflection layer to emit the light to the first optical transmission line.

8. The optical component according to claim 2, which is provided in a first optical transmission apparatus,
the optical component further comprising:
a control circuit configured to control each of the electro-optical crystal layers to be in the first state according to the signal in a case where the first optical transmission apparatus performs optical communication with a second optical transmission apparatus via the first optical transmission line and the second optical transmission line, and configured to control each of the electro-optical crystal layers to be in the second state according to the signal in a case where an abnormality is detected in the optical communication.
